(19) United States
(12) Patent Application Publication
(10) Pub. No.: US 2021/0240354 A1
(43) Pub. Date: Aug. 5, 2021

(54) INFORMATION PROCESSING SYSTEM, INFORMATION PROCESSING DEVICE, AND ACCESS CONTROL METHOD

(71) Applicant: FUJITSU LIMITED, Kawasaki-shi (JP)

(72) Inventor: OSAMU SHIRAKI, Kawasaki (JP)

(73) Assignee: FUJITSU LIMITED, Kawasaki-shi (JP)

(21) Appl. No.: 17/129,990

(22) Filed: Dec. 22, 2020

(30) Foreign Application Priority Data
Feb. 5, 2020 (JP) 2020-017958

(51) Int. Cl. G06F 3/06; G06F 9/48

(52) U.S. Cl. CPC G06F 3/0611; G06F 3/0673; G06F 3/0659; G06F 9/4843

(57) ABSTRACT

An information processing system includes: a plurality of information processing devices; and a management device, wherein the management device selects a second device from among a plurality of first devices determined on a basis of identification information of an object from among the plurality of information processing devices, the plurality of first devices each storing the same object identified by the identification information, and arranges a task that uses the object in the second device, and the second device generates specification information for specifying the second device from among the plurality of first devices on a basis of the identification information, and accesses the object stored in the second device on a basis of the specification information when accessing the object by execution of the task by the second device.

### CROSS-REFERENCE TO RELATED APPLICATION

This application is based upon and claims the benefit of priority of the prior Japanese Patent Application No. 2020-17958, filed on Feb. 5, 2020, the entire contents of which are incorporated herein by reference.

### FIELD

The embodiments discussed herein are related to an information processing system, an information processing device, and an access control method.

### BACKGROUND

Distributed object storage systems are widely used because of their high scalability characteristics. Generally, in such a storage system, the same object is stored in a plurality of locations to make data redundant. For example, in Ceph's object storage system, the controlled replication under scalable hashing (CRUSH) algorithm uniquely determines a plurality of storage locations for the same object from an object name.

Japanese Laid-open Patent Publication No. 2015-170201 and Japanese Laid-open Patent Publication No. 2014-229088 are disclosed as related art.

### SUMMARY

According to an aspect of the embodiments, an information processing system includes; a plurality of information processing devices; and a management device, wherein the management device selects a second device from among a plurality of first devices determined on a basis of identification information of an object from among the plurality of information processing devices, the plurality of first devices each storing the same object identified by the identification information, and arranges a task that uses the object in the second device, and the second device generates specification information for specifying the second device from among the plurality of first devices on a basis of the identification information, and accesses the object stored in the second device on a basis of the specification information when accessing the object by execution of the task by the second device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example and a processing example of an information processing system according to a first embodiment;

FIG. 2 is a diagram illustrating a configuration example of an information processing system according to a second embodiment;

FIG. 3 is a diagram illustrating a hardware configuration example of a server;

FIG. 4 is a diagram illustrating a configuration example of process functions of a management server and a server;

FIG. 5 is a diagram for describing a method of allocating an OSD in Ceph;

FIG. 6 is a diagram illustrating an internal configuration example of an arrangement calculation unit;

FIG. 7 is a flowchart illustrating a life cycle of a volume and a workload;

FIG. 8 is an example of a sequence diagram illustrating a processing procedure of creating a volume;

FIG. 9 is a diagram illustrating a configuration example of a volume management table;

FIG. 10 is an example of flowchart illustrating a processing procedure of workload deployment;

FIG. 11 is a first diagram illustrating a relationship between a workload and an OSD;

FIG. 12 is a second diagram illustrating a relationship between a workload and an OSD;

FIG. 13 is a diagram for describing a method of allocating an OSD in the second embodiment;

FIG. 14 is an example of a flowchart illustrating a processing procedure of mounting a volume to a workload;

FIG. 15 is an example of a flowchart illustrating a processing procedure of accessing an object;

FIG. 16 is an example of a sequence diagram illustrating a processing procedure of writing an object;

FIG. 17 is a diagram illustrating an internal configuration example of an arrangement calculation unit in a first modification;

FIG. 18 is an example (No. 1) of a flowchart illustrating a processing procedure of accessing an object in the first modification;

FIG. 19 is an example (No. 2) of the flowchart illustrating a processing procedure of accessing an object in the first modification;

FIG. 20 is a diagram illustrating an internal configuration example of an arrangement calculation unit in a second modification;

FIG. 21 is an example (No. 1) of a flowchart illustrating a processing procedure of accessing an object in the second modification; and

FIG. 22 is an example (No. 2) of the flowchart illustrating a processing procedure of accessing an object in the second modification.

### DESCRIPTION OF EMBODIMENTS

Meanwhile, in recent years, hyper-converged infrastructure (HCI) technology has attracted attention, which integrally implements a storage control function and an application execution function, using a general-purpose server.

Note that there are following proposals regarding the storage system. For example, the following data storage system based on Ceph has been proposed. In this data storage system, a storage control device determines a primary specifier for specifying a storage device closest to a client from among a plurality of storage devices in which the same data is stored, and changes an order of elements in an ordered set of the plurality of storage devices on the basis of the primary specifier. Then, the client accesses the storage device on the basis of the ordered set in which the order of elements has been changed.

Furthermore, the following data processing system has also been proposed. In this data processing system, master data is held in a first node, and slave data obtained by replicating master data is held in a second node. A routing manager changes the slave data in the second node to the master data and replicates the slave data, and holds the replicated slave data in a third node as new slave data.

By the way, in the above CRUSH algorithm, not only the plurality of storage locations for the same object but also a primary storage location among the plurality of storage locations is uniquely determined from the object name. The primary storage location is an access destination when a read is requested, and is a location where the object is first written when a write is requested.

Here, consider a case where the storage control function and the application execution function of the storage system in which a plurality of storage locations of an object is determined from an object name are implemented on a server by the HCI technology. In this case, for example, a management device, which manages execution of each task included in an application, selects a server in which the task is to be arranged from among a plurality of servers that stores an object to be used by the task. In this selection, for example, a server having a resource usage status suitable for execution of the task is selected as a task arrangement destination from among the plurality of servers.

Meanwhile, since the primary storage location of an object is determined from the object name of the object, the task is not necessarily arranged in the server that is the primary storage location of the object to be used. In the case where the server in which the task is arranged, and the server that serves as the primary storage location of the object are different, transfer of the object occurs between the servers when the object is accessed by execution of the task, and there is a problem of a decrease in access speed.

In one aspect, an information processing system, an information processing device, and an access control method for causing a possibility of improving the access speed for an object may be provided.

Hereinafter, embodiments will be described with reference to the drawings.

### First Embodiment

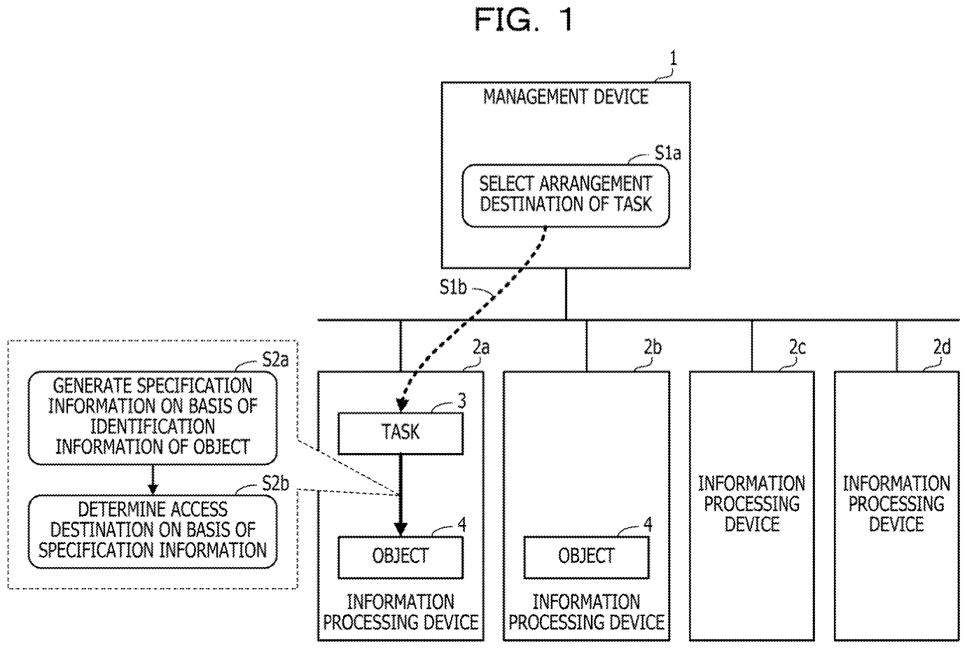

FIG. 1 is a diagram illustrating a configuration example and a processing example of an information processing system according to a first embodiment. The information processing system illustrated in FIG. 1 includes a management device 1 and a plurality of information processing devices. As an example, the information processing system illustrated in FIG. 1 includes four information processing devices 2a to 2d.

The management device 1 manages execution of a task in the information processing devices 2a to 2d. The task is, for example, part of processing by an application. The management device 1 determines a task arrangement destination from the information processing devices 2a to 2d, arranges the task in the information processing device determined as the arrangement destination, and causes the information processing device to execute the task.

The information processing devices 2a to 2d have a function to execute the task arranged by the management device 1 and a storage control function to manage data on an object basis and control an access to the object. Objects are distributed and stored in the information processing devices 2a to 2d. Furthermore, the same object is stored in two or more information processing devices among the information processing devices 2a to 2d, whereby the object is made redundant. Then, the two or more storage locations for the same object are uniquely determined on the basis of an identification number of the object.

In the example in FIG. 1, it is assumed that the same object is stored in two information processing devices. Furthermore, it is assumed that an object 4 used by a task 3 is stored in the information processing devices 2a and 2b on the basis of the identification number of the object 4.

In this case, the management device 1 specifies the information processing devices 2a and 2b in which the object 4 is to be stored from the information processing devices 2a to 2d. Then, the management device 1 selects the arrangement destination of the task 3 from the information processing devices 2a and 2b (step S1a). For example, the management device 1 selects the arrangement destination of the task 3 on the basis of a resource usage status in each of the information processing devices 2a and 2b. As an example in FIG. 1, it is assumed that the information processing device 2a is selected as the arrangement destination of the task 3, the management device 1 arranges the task 3 in the information processing device 2a (step S1b).

The information processing device 2a determines specification information for specifying the information processing device 2a itself from the information processing devices 2a and 2b in which the object 4 is to be stored on the basis of identification information (for example, the object name) of the object 4 (step S2a). Then, when the information processing device 2a accesses the object 4 by executing the task 3, the information processing device 2a accesses the object 4 stored in the information processing device 2a on the basis of the determined specification information (step S2b).

Thereby, the object 4 stored in the information processing device 2a in which the task 3 is arranged can be accessed. Therefore, the access speed can be improved as compared with a case of accessing the object 4 stored in the information processing device 2b.

For example, in an algorithm for determining a storage location of an object, not only the storage location but also the primary storage location may be determined from the identification information of the object. Meanwhile, the task arrangement destination by the management device 1 is not necessarily the information processing device that is the primary storage location. In the case where the task is arranged in an information processing device different from the information processing device that is the primary storage location, the information processing device in which the task is arranged transmits an access request for the object to the different information processing device when the information processing device accesses the object by executing the task. In this case, the access speed will decrease.

According to the present embodiment, when the desired object 4 is accessed by executing the task 3, the object 4 stored in the information processing device 2a in which the task 3 is arranged is accessed. Therefore, the possibility of improving the access speed occurs.

### Second Embodiment

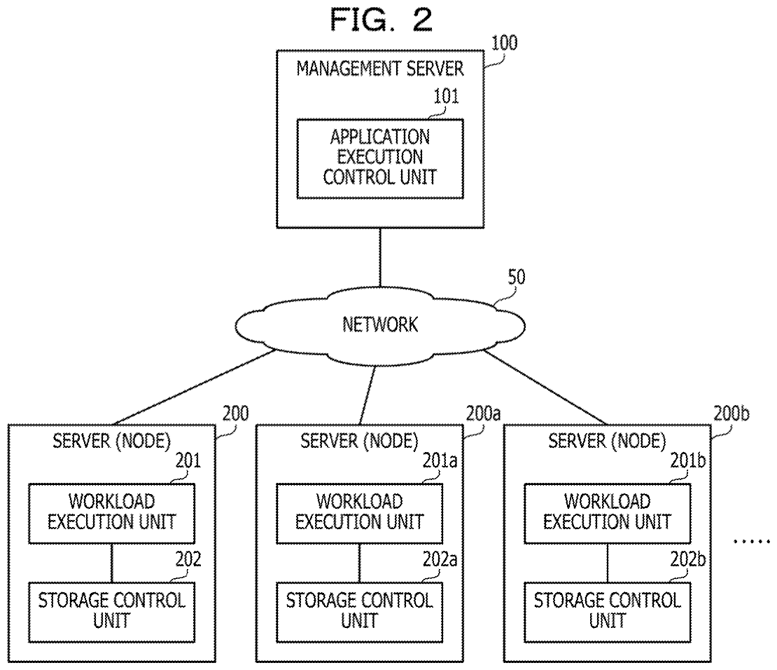

FIG. 2 is a diagram illustrating a configuration example of an information processing system according to a second embodiment. The information processing system illustrated in FIG. 2 includes a management server 100 and servers 200, 200a, 200b, and the like. The management server 100 and the servers 200, 200a, 200b, and the like are connected to one another via a network 50. Note that the management server 100 and the servers 200, 200a, 200b, and the like are implemented as, for example, general-purpose server computers,

The management server 100 includes an application execution control unit 101 that controls execution of an application using the servers 200, 200a, 200b, and the like. Processing of the application execution control unit 101 is implemented when, for example, a processor included in the management server 100 executes a predetermined program.

Application processing is managed in units of partial processing called “workload”. The application execution control unit 101 selects a server to deploy the workload from the servers 200, 200a, 200b, and the like, deploys the workload to the selected server, and causes the selected server to execute the workload.

Note that the workload is implemented as a task, for example. Furthermore, for example, the workload may be implemented as a container in a case of using a container-type virtualization technology. In this case, for example, when container information indicating a virtual process execution environment corresponding to the container is transmitted from the management server 100 to a server, the container is deployed in the server. Then, the container is activated in the server on the basis of the container information.

Meanwhile, each of the servers 200, 200a, 200b, and the like has a workload execution function and a storage control function to control an access to a storage. For example, the server 200 includes a workload execution unit 201 as the workload execution function and a storage control unit 202 as the storage control function. The workload execution unit 201 executes the workload deployed by the management server 100. The storage control unit 202 uses a storage device (local storage) included in the server 200 as a storage area of an object storage, and controls accesses to the storage area on an object basis.

The server 200a includes a workload execution unit 201a and a storage control unit 202a. The server 200b includes a workload execution unit 201b and a storage control unit 202b. The workload execution units 201a and 201b execute processing similar to the workload execution unit 201 of the server 200. The storage control units 202a and 202b execute processing similar to the storage control unit 202 of the server 200.

Note that the processing of the workload execution unit 201, 201a, 201b, or the like and the storage control unit 202, 202a, 202b, or the like is implemented when a processor of the server on which the respective units are mounted executes a predetermined program.

In the information processing system having the above configuration, a distributed object storage system in which each of the local storages of the servers 200, 200a, 200b, and the like are used as the storage areas by the storage control units 202, 202a, 202b, and the like is implemented. Furthermore, an HCI system is implemented as the storage control function and the application (workload) execution function are mounted in each of the servers 200, 200a, 200b, and the like.

Here, in the present embodiment, it is assumed that a Ceph object storage system is implemented as an example. The servers 200, 200a, 200b, and the like respectively operate as “nodes (storage nodes)” in Ceph.

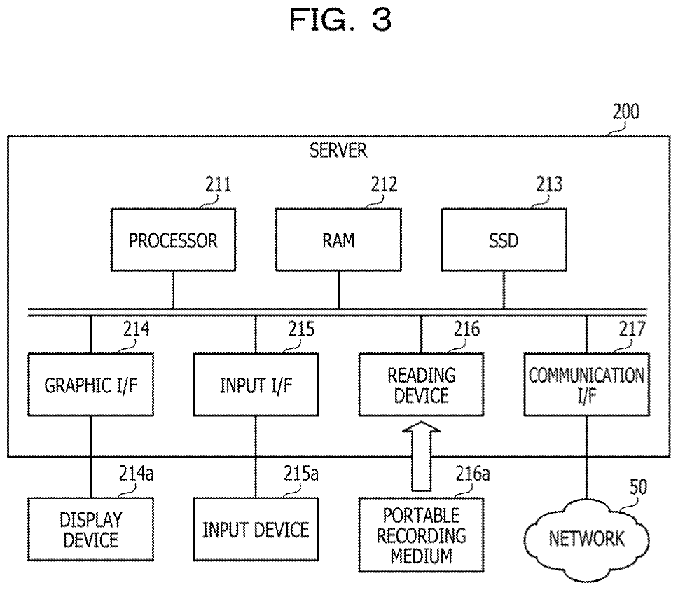

FIG. 3 is a diagram illustrating a hardware configuration example of a server. The server 200 is implemented as, for example, a computer as illustrated in FIG. 3.

The server 200 includes a processor 211, a random access memory (RAM) 212, a solid state drive (SSD) 213, a graphic interface (I/F) 214, an input interface (I/F) 215, a reading device 216, and a communication interface (I/F) 217.

The processor 211 integrally controls the entire server 200. The processor 211 is, for example, a central processing unit (CPU), a micro processing unit (MPU), a digital signal processor (ESP), an application specific integrated circuit (ASIC), or a programmable logic device (PLD). Furthermore, the processor 211 may be a combination of two or more elements of the CPU, MPU, DSP. ASIC, and PLD.

The RAM 212 is used as a main storage device of the server 200. The RAM 212 temporarily stores at least a part of an operating system (OS) program and an application program to be executed by the processor 211. Furthermore, the RAM 212 further stores various data needed for the processing by the processor 211.

The SSD 213 is used as an auxiliary storage device of the server 200. The SSD 213 stores an OS program, an application program, and various data, Further, the SSD 213 is a storage device that implements a part of the storage area of the distributed object storage. Note that another type of nonvolatile storage device such as a hard disk drive (HDD) can also be used as the auxiliary storage device.

The graphic interface 214 is connected to a display device 214a. The graphic interface 214 displays an image on the display device 214a according to a command from the processor 211. Examples of the display device 214a include a liquid crystal display, an organic electroluminescence (EL) display, and the like.

The input interface 215 is connected to an input device 215a. The input interface 215 transmits a signal output from the input device 215a to the processor 211. Examples of the input device 215a include a keyboard, a pointing device, and the like. Examples of the pointing device include a mouse, a touch panel, a tablet, a touch pad, a track ball, and the like.

A portable recording medium 216a is attached to and detached from the reading device 216. The reading device 216 reads data recorded on the portable recording medium 216a and transmits the data to the processor 211. Examples of the portable recording medium 216a include an optical disc, a magneto-optical disc, a semiconductor memory, and the like.

The communication interface 217 transmits and receives data to and from another device such as the management server 100 via the network 50.

Processing functions of the server 200 can be implemented by the above-described hardware configuration. Note that the servers 200a, 200b, and the like and the management server 100 can also be implemented as computers having the configuration illustrated in FIG. 3.

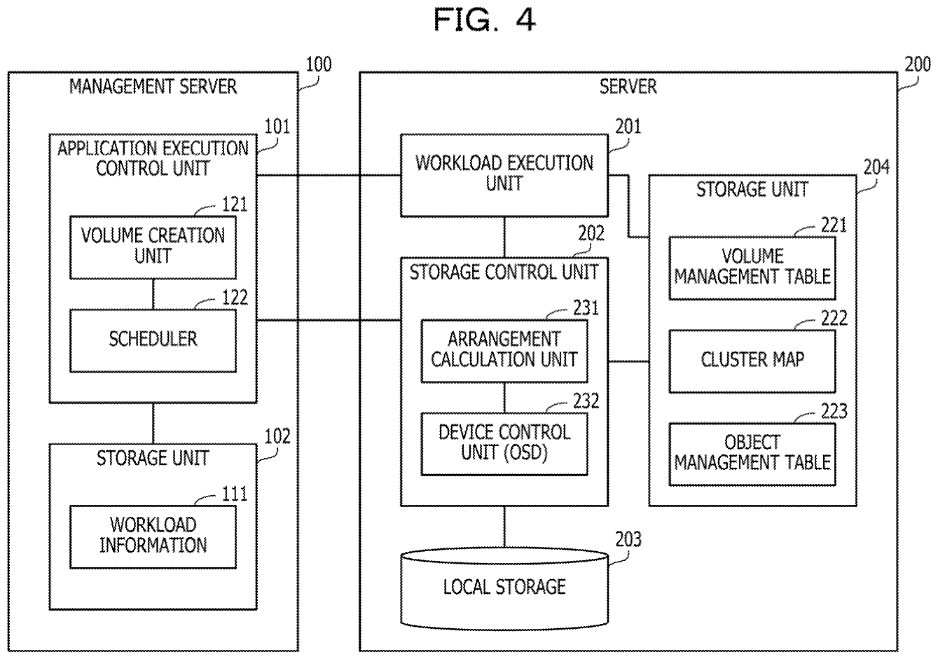

FIG. 4 is a diagram illustrating a configuration example of the process functions of the management server and the server.

First, the management server 100 includes a storage unit 102 in addition to the above-described application execution control unit 101. The storage unit 102 is implemented by the storage area included in the management server 100.

The storage unit 102 stores workload information 111. Information regarding each workload included in an application is registered in the workload information 111. For example, in the workload information 111, information indicating a volume accessed by a workload and information regarding a resource requested to the server side for executing the workload (resource request information) are registered. As the resource request information, for example, CPU ability, memory capacity, storage area capacity to be reserved for the volume, and the like are registered.

The application execution control unit 101 includes a volume creation unit 121 and a scheduler 122. The volume creation unit 121 creates the volume to be used by the workload. The volume is a logical storage area in which an object is stored. As described below, when the volume is mounted to the workload deployed in the server, the workload becomes accessible to the object in the volume. The scheduler 122 determines a deployment destination server for the workload on the basis of the resource request information corresponding to the workload and the resource usage status in each of the servers 200, 200a, 200b, and the like. The scheduler 122 deploys the workload to the server determined as the deployment destination and starts the operation of the workload.

Next, the server 200 includes a local storage 203 and a storage unit 204 in addition to the workload execution unit 201 and the storage control unit 202 described above. Note that the other servers 200a, 200b, and the like have similar processing functions to the server 200 although not illustrated.

The local storage 203 is a storage that implements a part of the storage area of the object storage system, and is implemented by a storage device included in the server 200 such as the SSD 213 in FIG. 3. The storage unit 204 is implemented by the storage area of the storage device included in the server 200 such as the RAM 212.

The storage unit 204 stores a volume management table 221, a cluster map 222, and an object management table 223. Information indicating correspondence between the volume and the object is registered in the volume management table 221. Information indicating the configuration of the Ceph object storage system is registered in the cluster map 222. In the cluster map 222, for example, information regarding configurations of a node (server) included in the system, an object storage device (OSD) to be described below arranged in the node, or the like is registered. In the object management table 223, the object name of the object stored in the local storage 203 and information indicating a storage destination are registered.

The workload execution unit 201 executes the workload deployed by the scheduler 122. Furthermore, the workload execution unit 201 mounts the volume to the workload in response to an instruction from the scheduler 122, and accesses the object in the volume by requesting the storage control unit 202 to access the volume.

The storage control unit 202 includes an arrangement calculation unit 231 and a device control unit 232. The arrangement calculation unit 231 obtains a position of an OSD corresponding to the local storage 203 in which the object is stored by calculation based on the object name. The device control unit 232 executes access processing for the local storage 203. The device control unit 232 operates as an OSD in the Ceph object storage system.

The OSD is provided for each local storage and executes the access processing for the corresponding local storage. At least one OSD is provided for each of the servers 200, 200a, 200b, and the like, and each OSD executes the access processing for the local storage of the server (node) in which the OSD itself is provided. In the case where one server (node) is provided with a plurality of local storages, the server is provided with an individual OSD for each local storage.

The arrangement calculation unit 231 determines an access destination OSD (device control unit) on the basis of the object name from the large number of OSDs provided in this way, and requests the OSD to access the object. In the case where the access destination is determined to be the OSD of another server (node), the arrangement calculation unit 231 requests the OSD of the other server to access the object.

Note that the local storage 203 may be implemented by one physical storage device or may be implemented by a plurality of physical storage devices. For example, the local storage 203 may be implemented by a plurality of physical storage devices controlled by redundant array of inexpensive disks (RAID).

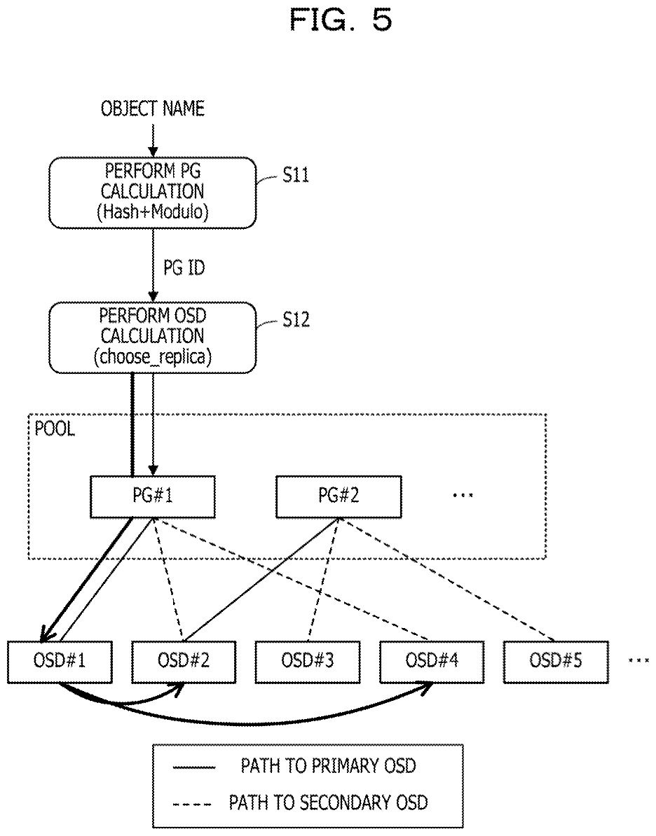

FIG. 5 is a diagram for describing a method of allocating an OSD in Ceph. As described above, at least one OSD is provided in each node. Each OSD executes the access processing for the corresponding local storage. The OSDs and the local storages are associated such that the access destinations of each ODS become different physical storage devices from one another.

An object is stored in local storages corresponding to a plurality of OSDs provided in different nodes. This makes the object redundant. Hereinafter, each of redundant objects (the same objects stored under different OSDs) will be referred to as a “replica”. Furthermore, in the following description, the number of replicas for each object is set to “3” as an example. In this case, the objects with the same object name are respectively stored in the local storages corresponding to the OSDs on three different nodes. Note that, in the following description, an object (or replica) being stored in the local storage corresponding to the OSD may be simply described as “the object (or replica) is stored in the OSD”.

One of the OSDs in which the three replicas are stored is a primary OSD, and the other two OSDs are secondary OSDs. In a case where a read of the object is requested, the replica stored on the primary OSD is read. Furthermore, when a write of the object is requested, first, the object is written in the primary OSD, then the object is transferred from the primary OSD to the two secondary OSDs, and the object is written in each of the secondary OSD. When the write to the three OSDs is complete, a response indicating write completion is sent.

Furthermore, in the Ceph object storage system, the storage area is managed as a “pool”, and the pool is divided into “placement groups (PGs)” and managed. A PG can also be said to be a management unit for one or more objects. The three OSDs (one primary OSD and two secondary OSDs) provided in different nodes are allocated to each of the PG.

The allocation of PGs to objects and the allocation of primary and secondary OSDs to PGs are determined using the following CRUSH algorithm.

First, calculation for determining a PG is performed on the basis of the object name (step S11). In this calculation, a hash value of the object name is calculated, and a remainder operation for obtaining a remainder of when the hash value is divided by the number of PGs (the number of existing PGs) is performed. A PG ID for identifying the PG is obtained by the calculation.

Next, calculation for determining the OSD is performed on the basis of the obtained PG ID and the cluster map 222 (step S12). In this calculation, for example, a function choose_replica is used. The PG ID and a replica number idx are input as arguments of the function choose_replica, and an OSD ID is output as a return value. In the case where the replica number idx=0 is input, the OSD ID of the primary OSD is output. In the case where the replica number idx=1 is input, the OSD ID of the first secondary OSD is output. In the case where the replica number idx=2 is input, the OSD ID of the second secondary OSD is output.

In CRUSH, the object is classified to the PG and managed, and the storage destination of the object is determined for each PG, whereby the object is efficiently distributed and arranged to the storage area of the node included in the object storage system.

By the way, in the OSD calculation immediately after the access request to the object is issued, usually, the replica number idx=0 is first input as the argument, and the OSD ID of the primary OSD is output accordingly. Hereinafter, the processing procedure when an access request is issued will be described with reference to FIG. 5.

FIG. 5 illustrates PG #1, PG #2, and the like, and OSD #1, OSD #2, OSD #3, OSD #4, OSD #5, and the like. For example, when a certain object name is specified and an access to an object is requested, it is assumed that the PG ID indicating the PG #1 is calculated in the PG calculation, and the OSD

ID indicating the OSD #1 is calculated as the primary OSD in the next OSD calculation. In this case, the access request for the object is input to the OSD #1 (device control unit), and the OSD #1 accesses the object in the corresponding local storage.

In the case where the access request is a read request, the OSD #1 reads the object and responds to the read request. On the other hand, in the case where the access request is a write request, the OSD #1 writes the object to the corresponding local storage. Moreover, the OSD #1 itself (or the node provided with the OSD #1) performs the PG calculation and the OSD calculation to obtain the OSD ID of the primary OSD. In the OSD calculation, the replica numbers idx=1, 2 are input respectively and the function choose_replica is executed, so that the OSD IDs of the two secondary OSDs are calculated.

In FIG. 5, it is assumed that the OSDs #2 and #4 are specified as the secondary OSDs, for example. In this case, the OSD #1 transfers the object to the OSDs #2 and #4 and requests a write. The OSDs #2 and #4 write the received object in the respective corresponding local storages. When such a write is complete, a response to the write request is sent

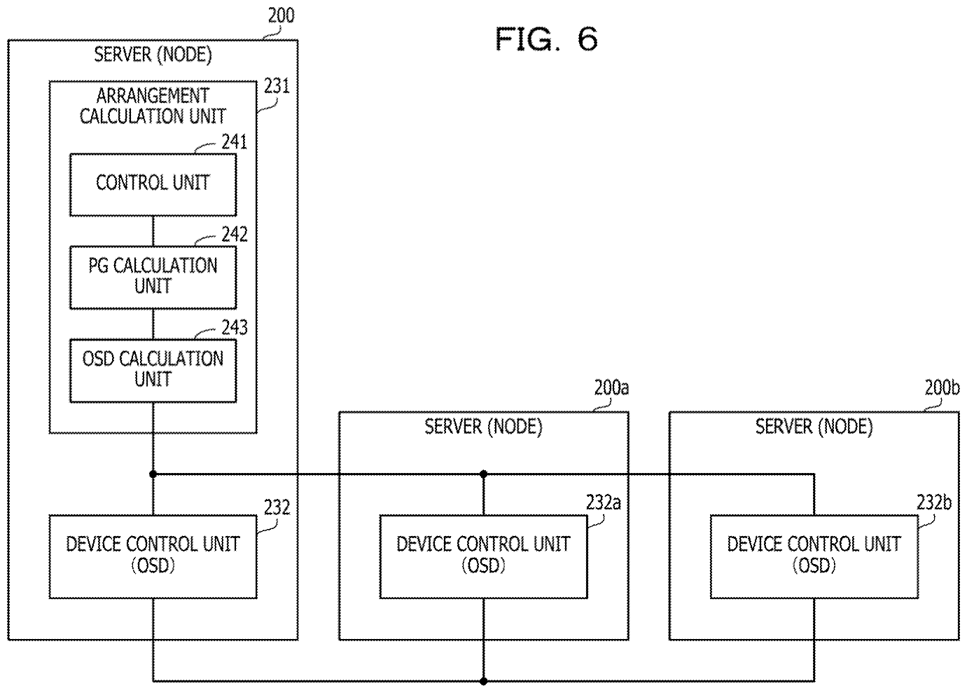

FIG. 6 is a diagram illustrating an internal configuration example of an arrangement calculation unit. As illustrated in FIG. 6, the arrangement calculation unit 231 includes a control unit 241, a PG calculation unit 242, and an OSD calculation unit 243.

The control unit 241 controls the processing of the entire arrangement calculation unit 231. For example, when the control unit 241 receives the access request for the volume from the started workload, the control unit 241 acquires the object name of the object included in the volume from the volume management table 221. Then, the control unit 241 outputs the acquired object name to the PG calculation unit 242 to start the PG calculation.

The PG calculation unit 242 calculates the PG ID on the basis of the input object name. The OSD calculation unit 243 calculates the OSD ID on the basis of the calculated PG ID and the cluster map 222.

The OSD calculation unit 243 outputs the access request for the object to the OSD (device control unit) indicated by the OSD ID. The OSD calculation unit 243 can output the access request not only to the OSD (device control unit 232) of the node (server 200 in FIG. 6) in which the OSD calculation unit 243 itself is provided but also to the OSD of another node (server).

FIG. 6 illustrates a device control unit 232a included in the server 200a and a device control unit 232b included in the server 200b, For example, in the case where the OSD ID corresponding to the device control unit 232a of the server 200a is calculated as the primary OSD, the OSD calculation unit 243 of the server 200 transmits the access request for the object to the device control unit 232a.

Furthermore, in the case where the access request is a write request, the device control unit writes the object and causes the PG calculation unit and OSD calculation unit on the node (server) in which the device control unit itself is provided to calculate the OSD ID of the secondary OSD. For example, in the case where the device control unit 232a is the primary OSD, the device control unit 232a writes the object and then calculates the OSD ID of the secondary OSD using the PG calculation unit and the OSD calculation unit (neither illustrated) of the server 200a as a calculation engine. Assuming that the device control units 232 and 232b are specified as the secondary OSDs, the device control unit 232a transfers the object to the device control units 232 and 232b to write the object.

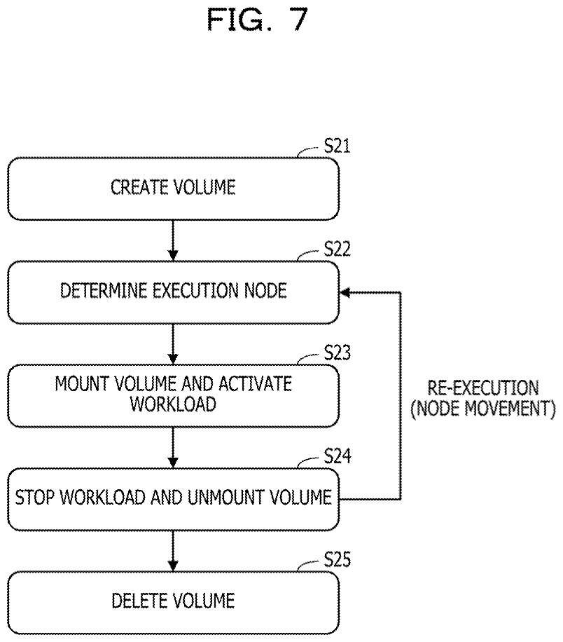

Next, FIG. 7 is a flowchart illustrating a life cycle of a volume and a workload. To enable the workload deployed in the node to operate while accessing the object, the volume to serve as the storage destination of the object is created in advance, and the volume needs to be mounted to the workload.

As illustrated in FIG. 7, first, the volume is created (step S21). At this time, the object name of the object included in the volume is also created, and the node in which the replica of the object is to be stored is determined on the basis of the object name.

Next, the node on which the workload is to be executed is determined (step S22). In this processing, the resource request information corresponding to the workload is acquired from the workload information 111. Then, the node that satisfies resource conditions indicated by the resource request information among the nodes in which the replicas of the object corresponding to the volume are stored is determined as an execution node.

Next, the workload is deployed to the determined execution node, and the volume is mounted to the workload. Thereby, the workload becomes accessible to the object in the volume. Then, the workload is then activated (step S23).

Here, for example, in a case where a processing load on the node in which the workload is executed becomes high or the like, for example, there are some cases where the operation of the workload is stopped once, and the deployment destination of the workload is moved to another node. When the operation of the workload is stopped, the volume is unmounted from the workload (step S24). In the case of moving the deployment destination of the workload, a node that satisfies the resource conditions indicated by the resource request information is determined again as a moving destination from among the nodes in which the replicas of the object corresponding to the volume are stored (step S22).

Furthermore, for example, when the operation of the workload is completed and the operation is terminated, the operation of the workload is stopped and the volume is unmounted from the workload (step S24). Then, the unmounted volume is deleted (step S25).

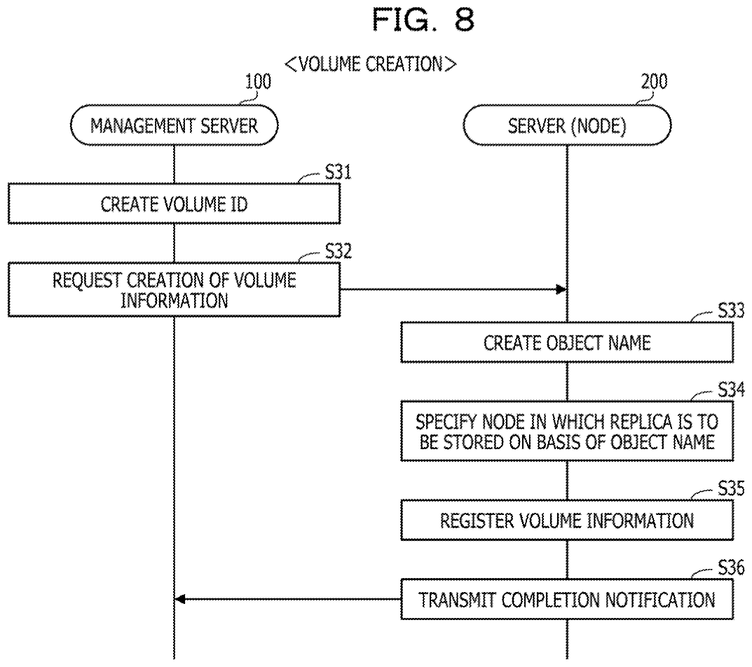

FIG. 8 is an example of a sequence diagram illustrating a processing procedure of creating a volume.

[step S31] The volume creation unit 121 of the management server 100 creates a volume ID indicating a new volume. The volume creation unit 121 registers the created volume ID in the workload information 111 in association with the workload.

[step S32] The volume creation unit 121 transmits the created volume ID to any of the servers 200, 200a, 200b, and the like to request creation of volume information. For example, a predetermined specific server is requested to create the volume information. Alternatively, all of the servers 200, 200a, 200b, and the like may be inquired about whether or not to be able to execute processing, and a server that returns a response that the processing is executable may be requested to create the volume information.

In the following description, it is assumed that the server 200 is requested to create the volume information as an example.

[step S33] The control unit 241 of the server 200 creates the object name of the object to be stored in the volume.

[step S34] The control unit 241 uses the PG calculation unit 242 and the OSD calculation unit 243 to specify the node in which the replica of the object is to be stored. For example, the control unit 241 inputs the created object name to the PG calculation unit 242. The PG calculation unit 242 calculates the PG ID on the basis of the input object name. The OSD calculation unit 243 calculates the OSD IDs of the primary OSD and the two secondary OSDs on the basis of the calculated PG ID and the cluster map 222. In this processing, the replica numbers idx=0, 1, 2 are respectively input as the arguments to the function choose replica, and the OSD IDs of the above three OSDs are calculated. The OSD calculation unit 243 specifies the node in which each OSD indicated by the calculated OSD ID is arranged, and notifies the control unit 241 of a node ID indicating each identified node.

[step S35] The control unit 241 creates volume information including the volume ID created in step S31, the object name created in step S33, and the node ID of each node specified in step S34, and registers the volume information in the volume management table 221. At this time, the control unit 241 registers the content of the volume information at least in the volume management table 221 held in each node specified in step S34. Alternatively, the updated content of the volume management table 221 on the server 200 may be synchronized in all servers (all nodes).

Furthermore, each node that registers the volume information in the volume management table 221 on its own node registers the created object name in the object management table 223 on its own node.

[step S36] The control unit 241 transmits a completion notification indicating that creation of the volume information has been completed to the management server 100.

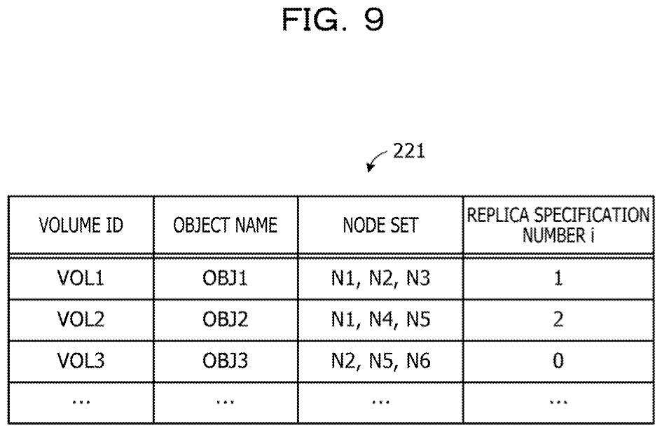

FIG. 9 is a diagram illustrating a configuration example of a volume management table. The volume ID, the object name, a node set, and a replica specification number i are registered in the volume management table 221 in association with one another.

The volume ID indicates an identification number of the volume. The object name indicates an identification name of the object stored in the volume. The node set indicates the node ID of each node in which the replica of the object is stored. The replica specification number i is a number for specifying how many replicas of the three replicas the replica number idx treats as primary. As described below, the replica specification number i is used to allow the workload to access the object at high speed.

The volume information created by the processing in FIG. 8 is registered as one record in the volume management table 221. Note that no value is registered in the item of the replica specification number i at the time when the record is registered.

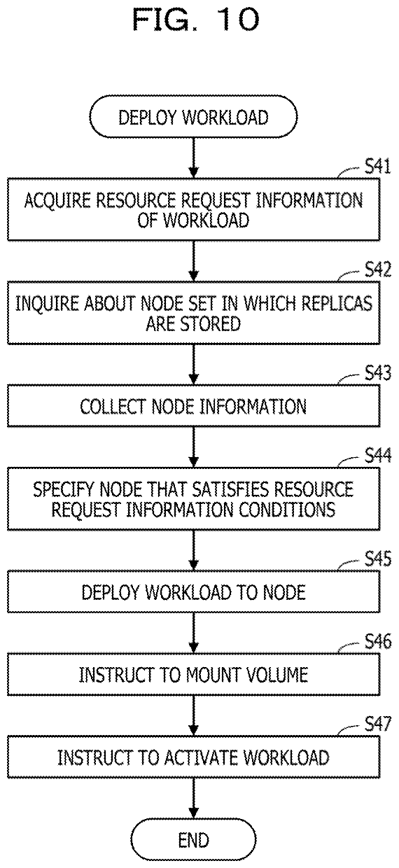

FIG. 10 is an example of a flowchart illustrating a processing procedure of workload deployment.

[step S41] The scheduler 122 of the management server 100 acquires the resource request information corresponding to the workload to be deployed from the workload information 111.

[step S42] The scheduler 122 acquires the volume ID corresponding to the workload to be deployed from the workload information 111. The scheduler 122 transmits the volume ID to the node (server) and inquiries about a set of nodes in which the replicas (replicas of the object in the volume) corresponding to the volume indicated by the volume ID are stored. The scheduler 122 acquires a node set notified in response to the inquiry. The node IDs included in the acquired node set indicate candidate deployment destination nodes for the workload.

In step S42, for example, the inquiry about a node set is transmitted to a plurality of nodes (which may be all the nodes). In the node that has received the inquiry, the control unit 241 refers to the volume management table 221 and notifies the management server 100 of the node set in the case where the volume ID and the corresponding node set are registered. Note that, in the case where the volume management table 221 is synchronized in all the nodes, the scheduler 122 only has to send the inquiry about a node set to any one of the nodes.

[step S43] The scheduler 122 collects node information from each node included in the acquired node set. As the node information, information indicating the resource usage status of the CPU, memory, and the like in the node is collected. For example, a CPU usage rate, a memory usage rate, and the like are collected.

[step S44] The scheduler 122 identifies a node that satisfies the conditions indicated by the resource request information from among the nodes included in the node set on the basis of the node information of each node collected in step S43. For example, a node having the CPU usage rate equal to or higher than a value included in the resource request information, and having the memory usage rate equal to or higher than a value included in the resource request information is specified. Thereby, the node in a state suitable for executing the workload is specified.

Note that, in a case where the node that satisfies all the conditions indicated by the resource request information is not present, a node that satisfies a largest number of conditions of the plurality of conditions included in the resource request information only has to be specified. Alternatively, a node having the resource usage status closest to the conditions indicated by the resource request information may be specified.

[step S45] The scheduler 122 deploys the workload to the identified node. For example, a program corresponding to the workload is transmitted to the specified node and installed on the node.

[step S46] The scheduler 122 instructs the workload deployment destination node to mount the volume indicated by the volume ID acquired from the workload information 111 in step S42 on the workload. When the scheduler 122 receives the mount completion notification, the processing proceeds to step S47.

[step S47] The scheduler 122 instructs the workload deployment destination node to activate the deployed workload. Thereby, the workload is activated on the deployment destination node, and the operation of the workload is started.

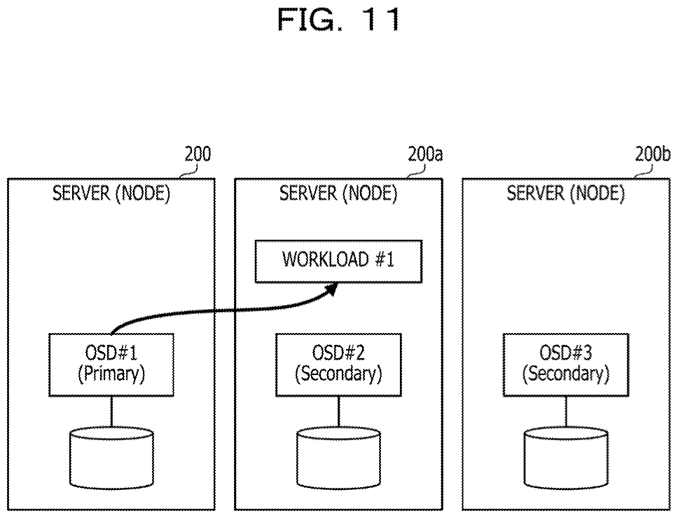

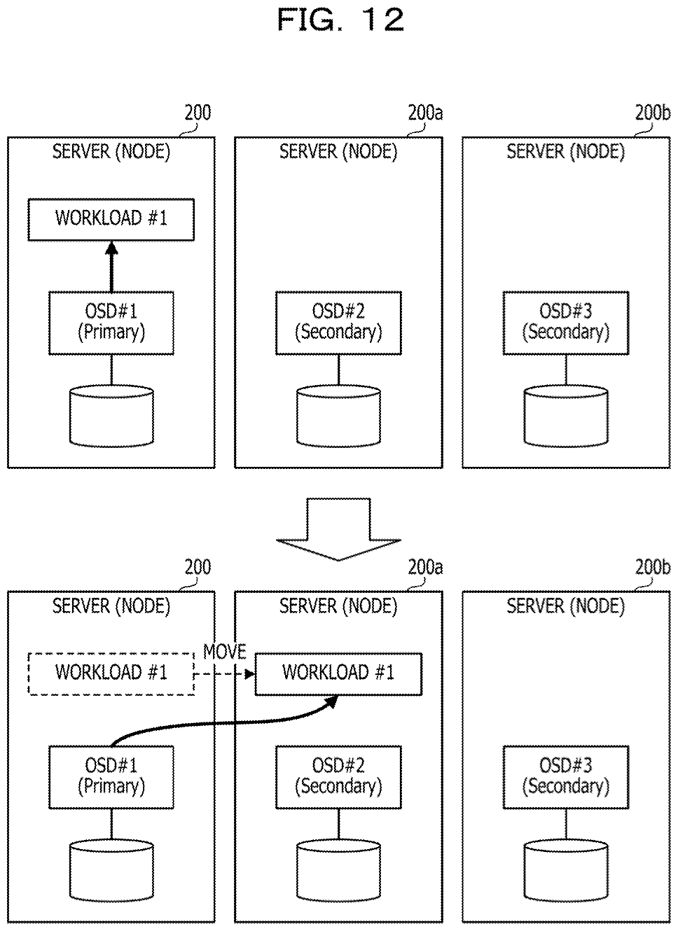

By the above processing, the workload is deployed to one of the nodes in which the replicas corresponding to the volume (the replicas of the object in the volume) are stored. Here, the relationship between the deployed workload and the OSD in which the replica of the object is stored will be described with reference to FIGS. 11 and 12.

FIG. 11 is a first diagram illustrating the relationship between the workload and the OSD. Furthermore, FIG. 12 is a second diagram illustrating the relationship between the workload and the OSD. As an example, it is assumed that the OSDs #1, #2, and #3 are present in the servers 200, 200a, and 200b, respectively, both in FIGS. 11 and 12. Furthermore, it is assumed that the replicas of the object included in the access destination volume of workload #1 are stored in the OSDs #1, #2, and #3. Moreover, it is assumed that the OSD #1 is the primary OSD for this object and the OSDs #2 and #3 are the secondary OSDs.

In such a case, the workload #1 is deployed to one of the servers 200, 200a, and 200b by the processing of scheduler 122 illustrated in FIG. 10. However, which of the servers 200, 200a, and 200b the workload #1 is deployed to is determined according to the resource usage statuses of the servers 200, 200a, and 200b, respectively.

Therefore, as illustrated in FIG. 11, the workload #1 may be deployed to the node where the secondary OSD is present. In the example in FIG. 11, the workload #1 is deployed to the server 200a in which the OSD #2, which is the secondary OSD, is present. In this case, when the workload #1 tries to access the object, the OSD ID of the OSD #1 is calculated by the OSD calculation, and the OSD calculation unit 243 of server 200a transmits the access request to the OSD #1 of the server 200.

In the case where the access request is a read request, the object read by the OSD #1 is transferred from the server 200 to the server 200a and passed to the workload #1, as illustrated by the arrow in FIG. 11. As described above, there is a problem that the time from issuance of the read request to the response becomes longer by the time of transferring the object between the servers (nodes).

Furthermore, in the case where the access request is a write request, the time from issuance of the write request to the response also becomes long. For example, in the case where the OSD #2 is the primary OSD, the object is transferred from the server 200a to the servers 200 and 200b after the object is written by the OSD #2. Then, the object is written by the OSDs #1 and #3. In this case, the object is transferred between the servers twice.

Meanwhile, in the case in FIG. 11, first, the object is transferred from the server 200a to the server 200, and the object is written by the OSD #1. Next, the object is transferred from the server 200 to the servers 200a and 200b, and the object is written by the OSD #2 and #3. In this case, the object is transferred between the servers three times. As the number of object transfers increases in this way, the time from the issuance of the write request to the response becomes longer.

Moreover, the deployment destination of the workload may be moved, as illustrated in FIG. 12. In the case in FIG. 12, the workload #1 is moved from server 200 to server 200a. As such a case, for example, a case where a processing load on the server 200 is high or a case where a processing load on the server 200a is relatively lower than the processing load of the server 200 is conceivable.

Before the movement of the workload #1, the workload #1 is deployed in the server 200 where the primary OSD is present, as illustrated in the upper part in FIG. 12. Meanwhile, after the movement of the workload #1, the workload #1 is deployed in the server 200a where the secondary OSD is present, as illustrated in the lower part in FIG. 12. Therefore, the case in FIG. 12 has a problem that the time to access the object increases due to the movement of the workload #1.

Therefore, in the present embodiment, what number's replica the replica of the object stored in the OSD of its own node is (what value the replica number idx is) is determined in the node (server) where the workload has been deployed. Then, the determined replica number is specified at the time of OSD calculation. Thereby, the OSD ID indicating the OSD of the node to which the workload has been deployed is calculated, and the access request is output to that OSD. By such processing, the OSD existing in the node where the workload has been deployed is regarded as the primary OSD, and the access request is output to the OSD first, and the access speed is increased.

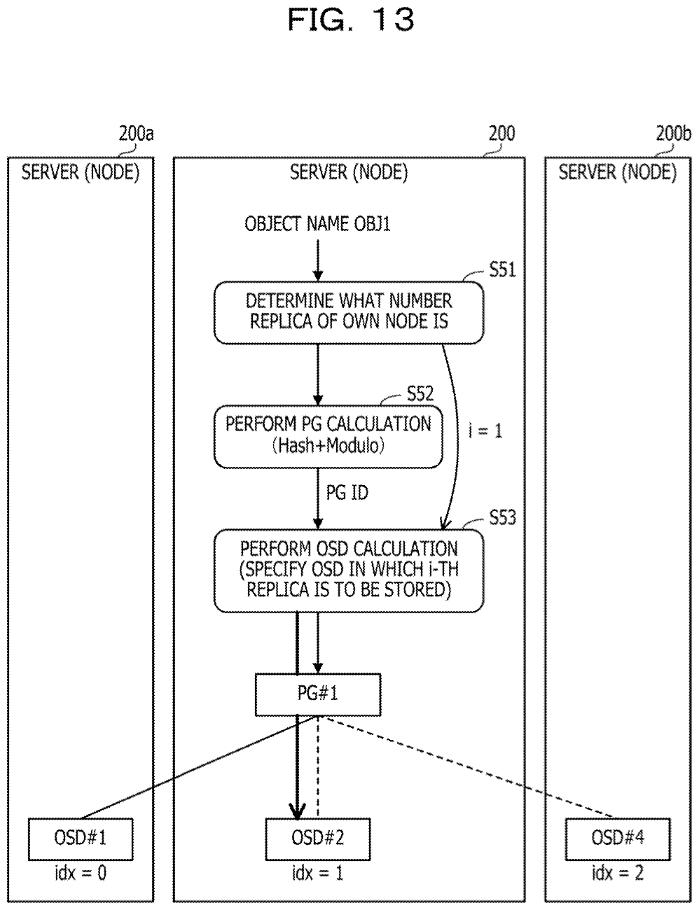

FIG. 13 is a diagram for describing a method of allocating an OSD in the second embodiment. In FIG. 13, it is assumed that the replicas of the object with an object name OB31 are stored in the OSDs #1, #2, and #4. It is assumed that the OSD #1 is present in the server 200a, the OSD #2 is present in the server 200, and the OSD #4 is present in the server 200b.

Furthermore, in the OSD calculation, in the case where the replica number idx=0 is input as the argument of the function choose_replica, the OSD ID of the OSD #1 is output. Furthermore, in the case where the replica number idx=1 is input, the OSD ID of the OSD #2 is output, and in the case where the replica number idx=2 is input, the OSD ID of the OSD #4 is output. That is, in the OSD calculation of normal Ceph, the OSD #1 is determined to be the primary OSD.

In FIG. 13, it is assumed that the workload is deployed to the server 200, and the workload accesses the object name OBJ1. In this case, the control unit 241 of the server 200 first determines what number's replica the replica to be stored in the OSD of its own node (server 200) is (step S51). This determination processing is executed using the PG calculation unit 242 and the OSD calculation unit 243. The PG calculation unit 242 calculates the PG ID on the basis of the object name OBJ1 (step S52). The OSD calculation unit 243 inputs the replica numbers idx=0, 1, 2 in order as the arguments of the function choose_replica to calculate the respective OSD IDs. In the case where the calculated OSD ID indicates the OSD existing in its own node (server 200) the input replica number idx is obtained as a determination result. The obtained replica number idx is registered in the volume management table 221 as the replica specification number i in association with the object name.

The replica specification number i is used for specifying an OSD that is operated in a pseudo manner as the primary OSD from among the OSDs in which the replicas of the object are stored. That is, when an access to the object with the object name OBJ1 is requested, the replica specification number i corresponding to the object is acquired from the volume management table 221 and the OSD calculation is performed in consideration of the replica specification number i. For example, first, the OSD calculation unit 243 calculates the OSD ID by inputting the replica number idx=i as the argument of the function choose_replica (step S53). Thereby, the OSD in which the i-th replica is be stored is specified.

The OSD calculation unit 243 outputs the access request to the OSD indicated by the calculated OSD ID. At this time, the output destination of the access request is the OSD that exists in the same node as the output source OSD calculation unit 243. In the case in FIG. 13, the access request is output to the OSD #2. Thereby, the output destination of the access request by the workload is the OSD in the node to which the workload has been deployed, and the possibility of shortening the time to access the object and improving the access speed occurs, as compared with the processing illustrated in FIG. 5.

That is, in the case where a read is requested, the object is read from the OSD in the node to which the workload has been deployed. Furthermore, in the case where a write is requested, the object is first written to the OSD in the node to which the workload has been deployed. Therefore, the possibility of improving the access speed for the object occurs.

In a case where a large number of workloads is deployed by the scheduler 122, or in a case where the deployment destinations of some of the workloads are moved, the read speed and write speed of the object can be improved as a whole.

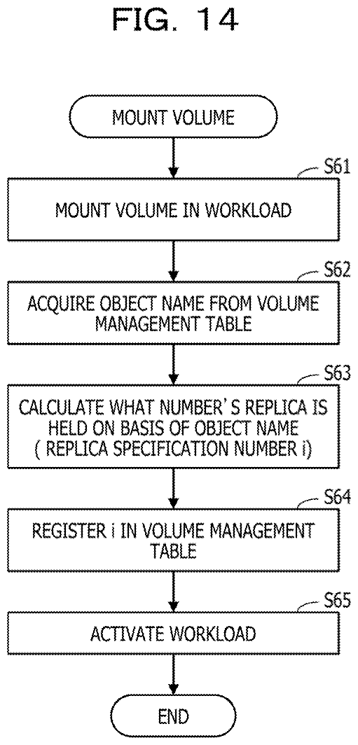

Here, as an example in the present embodiment, it is assumed that the calculation of the replica specification number i in step S51 is executed at the time when the volume including the object is mounted on the workload. Processing in this case is illustrated in FIGS. 14 to 16 below. In this example, after the workload is deployed to the node, the replica specification number i is calculated only once, there is no need to calculate the replica specification number i each time an access to the object is requested.

However, as another example, the replica specification number i may be calculated each time an access to the object is requested. In this case, when an access to the object is requested, the replica specification number i in step S51 is calculated. However, the replica specification number i is not registered in the volume management table 221 and is directly used in the OSD calculation (step S53) after the PG calculation (step S52).

FIG. 14 is an example of a flowchart illustrating a processing procedure of mounting a volume to a workload. Here, as an example, a case which the workload is deployed to the server 200 will be described.

[step S61] When the mount execution instruction is transmitted from the scheduler 122 of the management server 100 in step S46 in FIG. 10, the workload execution unit 201 of the server 200 receives the mount execution instruction together with the volume ID. The workload execution unit 201 mounts the volume indicated by the volume ID on the workload.

[step S62] The workload execution unit 201 notifies the control unit 241 of the volume ID. The control unit 241 acquires the object name associated with the notified volume ID from the volume management table 221.

[step S63] What number's replica is held among the replicas of the object corresponding to its own node (management server 100) is calculated on the basis of the object name. For example, the PG calculation unit 242 calculates the PG ID on the basis of the object name. The OSD calculation unit 243 inputs the replica numbers idx=0, 1, 2 in order as the arguments of the function choose_replica to calculate the respective OSD IDs. The OSD calculation unit 243 notifies the control unit 241 of the replica number idx input when the calculated OSD ID indicates the OSD existing in the own node (server 200), of the replica numbers idx inputs as the arguments.

[step S64] The control unit 241 registers the notified replica number idx as the replica specification number i in the volume management table 221 in association with the volume ID and the object name.

[step S65] The workload execution unit 201 activates the deployed workload. Thereby, the operation of the workload is started.

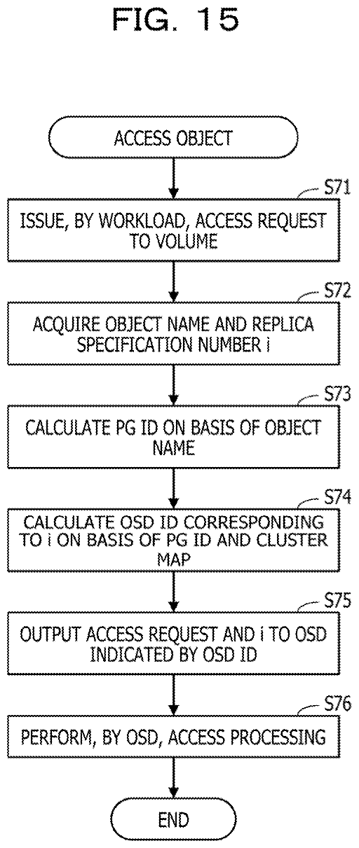

FIG. 15 is an example of a flowchart illustrating a processing procedure of accessing an object. Here, as an example, it is assumed that the workload deployed to the server 200 is executed by the workload execution unit 201.

[step S71] The workload issues the access request for the volume.

As a result, the access request is output from the workload execution unit 201 to the storage control unit 202 together with the volume ID.

[step S72] The control unit 241 acquires the object name and the replica specification number i associated with the volume ID from the volume management table 221.

[step S73] The PG calculation unit 242 calculates the PG ID on the basis of the object name.

[step S74] The OSD calculation unit 243 calculates the OSD ID of the OSD corresponding to the replica specification number i on the basis of the calculated PG ID and the cluster map 222. For example, the OSD ID is calculated by inputting the replica number idx=i as the argument of the function choose_replica.

[step S75] The OSD calculation unit 243 outputs the access request for the object and the replica specification number i to the OSD indicated by the calculated OSD ID. The output destination at this time is the OSD (device control unit 232) present in its own node (that is, the server 200).

[step S76] The access processing by the OSD is executed. In the case where a read of the object is requested, the OSD (the device control unit 232 of the server 200) on the output destination in step S75 reads the object from the corresponding local storage 203 on the basis of the object management table 223. The read object is output to the workload execution unit 201, and the read completion notification is output from the storage control unit 202 to the workload execution unit 201. Thereby, the object is used by the workload.

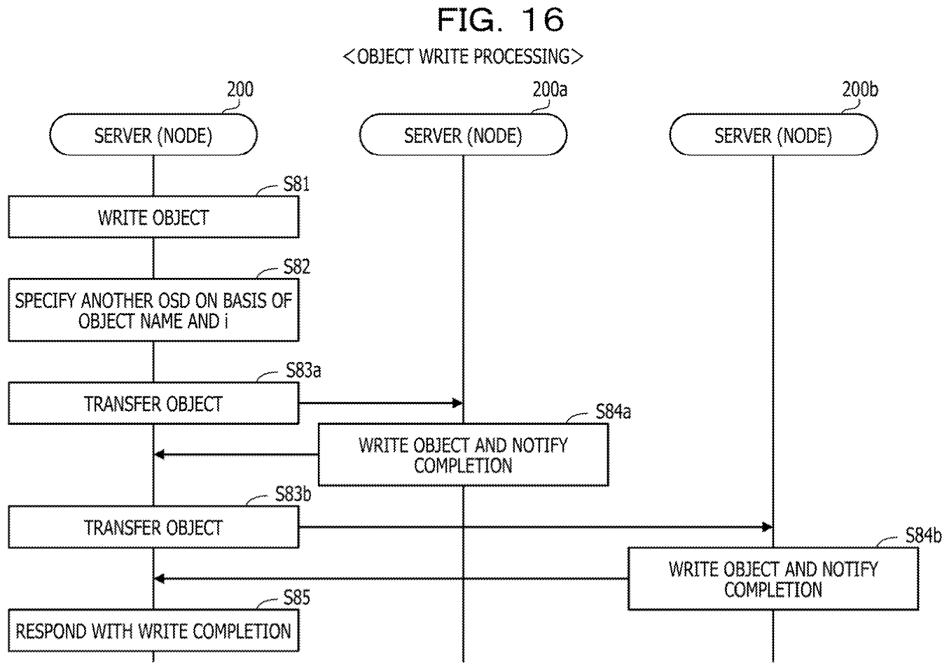

Meanwhile, in the case where a write of the object is requested, the processing illustrated in FIG. 16 below is executed.

FIG. 16 is an example of a sequence diagram illustrating a processing procedure of writing an object.

[step S81] The OSD (device control unit 232) of the server 200 writes the object in the corresponding local storage 203.

[step S82] The OSD of the server 200 notifies the arrangement calculation unit 231 of the object name and the replica specification number i, and requests calculation of the OSD ID indicating another OSD in which the replica of the object is to be stored. In the arrangement calculation unit 231, the PG calculation unit 242 calculates the PG ID on the basis of the object name. The OSD calculation unit 243 calculates the OSD ID of the OSD corresponding to a replica number other than the replica specification number i on the basis of the calculated PG ID and the cluster map 222. For example, two numerical values other than the replica specification number i are input in order as the replica numbers idx as the arguments of the function choose replica, so that respective OSD IDs are calculated. For example, in the case where the replica specification number i=1, the replica numbers idx=0, 2 are input as the arguments, and the OSD IDs are respectively calculated.

Note that the OSD ID calculation processing in step S82 may be executed by the OSD itself of the server 200.

Hereinafter, the description will be given assuming that the 0SDs existing in the servers 200a and 200b are specified as other OSDs.

[step S83a] The OSD of the server 200 transfers the object to the OSD of the server 200a and gives an instruction to write the object.

[step S83b] The OSD of the server 200 transfers the object to the OSD of the server 200b and gives an instruction to write the object.

[step S84a] The OSD (device control unit 232a) of the server 200a writes the object in the corresponding local storage. When the write is completed, the OSD of the server 200a transmits the completion notification to the OSD of the server 200.

[step S84b] The OSD (device control unit 232b) of the server 200b writes the object in the corresponding local storage. When the write is completed, the OSD of the server 200b transmits the completion notification to the OSD of the server 200.

[step S85] When the OSD of the server 200 receives the write completion notification from both the OSD of the server 200a and the OSD of the server 200b, the OSD of the server 200 outputs response information indicating the write completion to the arrangement calculation unit 231. The response information is transferred from the arrangement calculation unit 231 to the workload execution unit 201, and the workload being executed receives the response information.

In the above-described second embodiment, when the workload accesses the object, the workload can specify the OSD to be operated as the primary OSD from among the OSDs in which the replicas of the object are stored according to the replica specification number i. With the specification, the OSD on the node to which the workload is deployed can be operated as the primary OSD in a pseudo manner.

As a result, the access request from the arrangement calculation unit 231 is output to the OSD on the node to which the workload is deployed. In the case where a read is requested, the OSD reads the object, and when a write is requested, the OSD writes the object first.

Thereby, the possibility of improving the access speed for the object occurs. That is, in the case where the primary OSD is present in another node, the number of object transfers between nodes is reduced (the number of transfers becomes “0” in the case of the read request). Therefore, the access speed is improved, Furthermore, in the case where a large number of workloads is deployed or in the case where the deployment destinations of some of the workloads are moved, the access speed of the object can be improved as a whole. Furthermore, since the number of object transfers between nodes is reduced, the load on the network 50 can be reduced.

Furthermore, in the second embodiment, the effect of improving the access speed from the workload to the object can be expected while deploying the task to the node that satisfies the resource conditions for the workload and enabling the node to execute the task. For example, a method of deploying the workload to the node including the primary OSD is conceivable but in this method, the workload may not be executed in an appropriate node that satisfies the resource conditions. According to the second embodiment, the workload can be executed in the appropriate node. Therefore, both optimization of deployment of the workload and optimization of the object on the access destination can be achieved.

Next, modifications in which a part of the processing in the second embodiment is changed will be described.

In the following first and second modifications, whether to execute processing of calculating the replica specification number i (corresponding to steps S62 to S64 in FIG. 14) can be specified when mount of the volume is specified by the scheduler 122 in step S46 in FIG. 10. In the mount processing in FIG. 14, the processing in steps S62 to S64 is executed only when execution of the processing of calculating the replica specification number i is instructed. By such processing, when the workload tries to access the object, a case where the replica specification number i is registered for the object and a case where the replica specification number i is not registered occur.

<First Modification>

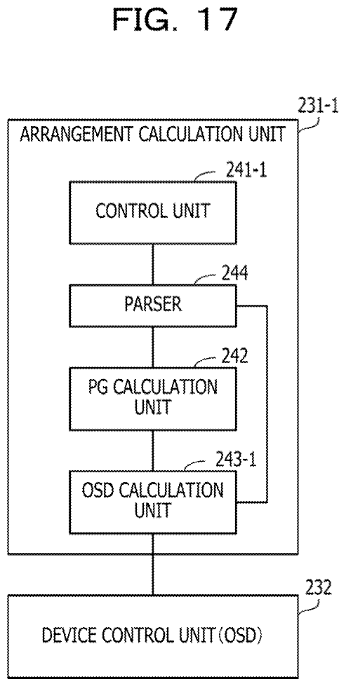

FIG. 17 is a diagram illustrating an internal configuration example of an arrangement calculation unit in a first modification. In the first modification, the server 200 includes an arrangement calculation unit 231-1 illustrated in FIG. 17 instead of the arrangement calculation unit 231 illustrated in FIG. 6. Note that, in FIG. 17, components that execute the same processing as in FIG. 6 are illustrated with the same reference numerals. Furthermore, other servers have the same configuration as the server 200.

The arrangement calculation unit 231-1 includes a control unit 241-1 and an OSD calculation unit 243-1 instead of the control unit 241 and the OSD calculation unit 243 in FIG. 6. Moreover, the arrangement calculation unit 231-1 includes a parser 244.

The control unit 241-1 is different from the control unit 241 in FIG. 6 in embedding a predetermined magic pattern and the replica specification number i in a specific field in a character string of the object name and outputting the character string when the replica specification number i is calculated. The magic pattern is identification information indicating that the replica specification number i has been specified.

The parser 244 determines whether the magic pattern is present in the specific field of the object name when the object name is output together with the access request to the object from the control unit 241-1. In a case where the magic pattern is not present, the parser 244 transfers the object name as it is to the PG calculation unit 242. On the other hand, in a case where the magic pattern is present, the parser 244 extracts the replica specification number i from the object name and notifies the OSD calculation unit 243-1 of the replica specification number i. At the same time, the parser 244 masks an area of the magic pattern and the replica specification number i in the object name, and outputs the masked object name to the PG calculation unit 242.

The OSD calculation unit 243-1 is different from the OSD calculation unit 243 in FIG. 6 in inputting the replica number idx=i as the argument to the function choose_replica in the case where the replica specification number i is notified from the parser 244, and inputting the replica number idx=0 in the case where the replica specification number i is not notified.

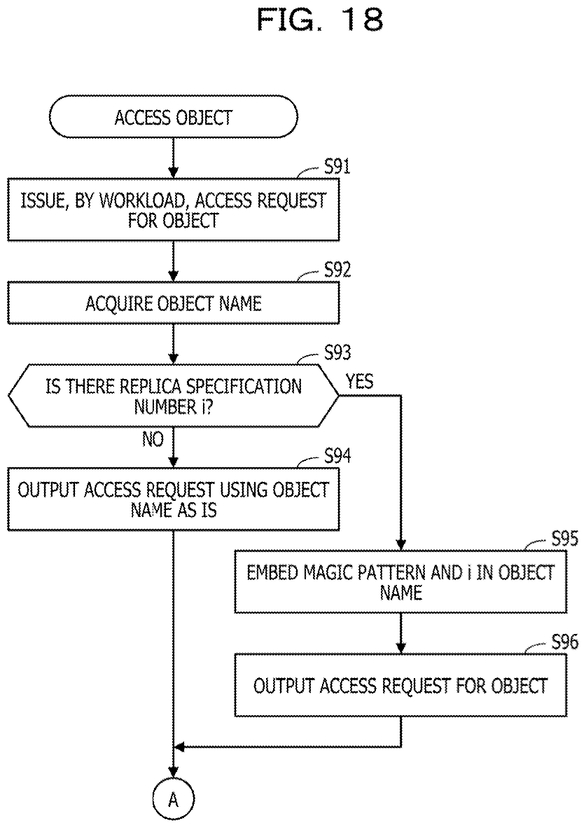

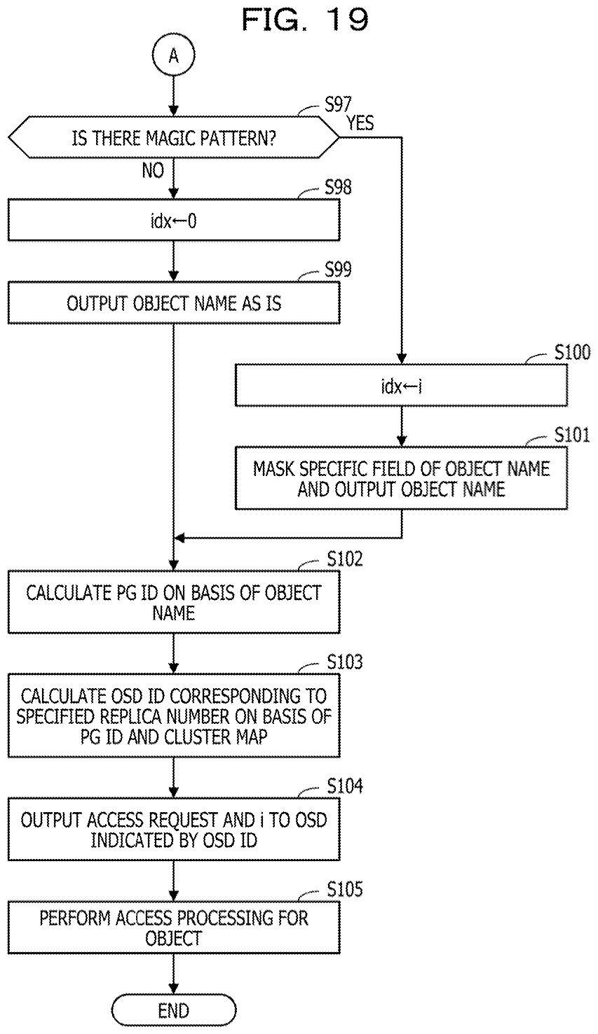

FIGS. 18 and 19 are examples of a flowchart illustrating a processing procedure of accessing an object in the first modification. As an example, it is assumed that the workload deployed to the server 200 is executed by the workload execution unit 201 in FIGS. 18 and 19, similarly to FIG. 15.

[step S91] The workload issues the access request for the volume. As a result, the access request is output from the workload execution unit 201 to the storage control unit 202 together with the volume ID.

[step S92] The control unit 241-1 acquires the object name associated with the volume ID from the volume management table 221.

[step S93] The control unit 241-1 determines whether the replica specification number i is registered for the volume ID in the volume management table 221. In the case where the replica specification number i is registered, the control unit 241-1 acquires the replica specification number i and advance the processing to step S95. On the other hand, in the case where the replica specification number i is not registered, the control unit 241-1 advances the processing to step S94.

[step S94] The control unit 241-1 outputs the access request o the object using the object name as it is.

[step S95] The control unit 241-1 embeds the magic pattern and the replica specification number i in the specific field of the object name.

[step S96] The control unit 241-1 outputs the access request for the object by using the object name in which the magic pattern and the replica specification number i are kept embedded.

[step S97] The parser 244 receives the access request output in step S94 or step S96, analyzes the object name indicating the access destination, and determines whether there is the magic pattern in the specific field of the object name. The processing proceeds to step S100 in the case where there is the magic pattern, and the processing proceeds to step S98 in the case where there is no magic pattern.

[step S98] The parser 244 specifies “0” as the replica number idx, which is the argument of the function choose_replica, to the OSD calculation unit 243.

[step S99] The parser 244 outputs the object name as it is to the PG calculation unit 242.

[step S100] The parser 244 extracts the replica specification number i from the object name, and specifies the replica specification number I as the replica number idx, which is the argument of the function choose_replica, to the OSD calculation unit 243-1.

[step S101] The parser 244 masks specific fields of the object name and outputs the masked object name to the PG calculation unit 242. The masked fields are a field in which the magic pattern is described and a field in which the replica specification number i is described.

[step S102] The PG calculation unit 242 calculates the PG ID on the basis of the object name. In this calculation, the original object name is used as it is in the case where step S99 is executed, whereas the object name with masked some fields is used in the case where step S101 is executed.

[step S103] The OSD calculation unit 243-1 calculates the OSD ID of the OSD corresponding to the replica number idx specified in step S98 or step S100 on the basis of the calculated PG ID and the cluster map 222. That is, the OSD ID is calculated by inputting the replica number idx specified in step S98 or S100 as the argument of the function choose_replica.

[step S104] The OSD calculation unit 243-1 outputs the access request for the object to the OSD indicated by the calculated OSD ID. At this time, the object name output in step S99 or step S101 is specified as the object to be accessed, Furthermore, when steps S100 and S101 are executed, the OSD calculation unit 243-1 outputs the replica specification number i together with the access request to the OSD indicated by the calculated OSD ID.

Here, in the case where steps S100 and S101 are executed, the output destination of the access request is the OSD (device control unit 232) existing in its own node (that is, the server 200). Meanwhile, in the case where steps S98 and S99 are executed, the output destination of the access request may be the OSD existing in its own node or may be the OSD existing in another node. In the latter case, the access request is transferred to another node (server) via the network 50.

[step S105] The access request is received by the OSD on the output destination, and the access processing by the OSD is executed. In the case where steps S100 and S101 are executed, in step S105, processing similar to in step S76 in FIG. 15 is executed. Meanwhile, in the case where steps S98 and S99 are executed, the following processing is performed.

In the case where a read of the object is requested, the OSD reads the object from the corresponding local storage 203 on the basis of the object management table 223. Here, in the case where the OSD is present in the server 200, the read object is output to the workload execution unit 201 of the server 200, and the read completion notification is output from the storage control unit 202 to the workload execution unit 201. On the other hand, in the case where the OSD is present in a server other than the server 200, the read object is transferred to the arrangement calculation unit 231-1 of the server 200. The transferred object is output to the workload execution unit 201 of the server 200, and the read completion notification is output from the storage control unit 202 to the workload execution unit 201.

In the case where a write of the object is requested, the following processing is executed. Here, description will be given based on FIG. 16. The access request output in step S104 is output to the OSD (primary OSD) with the replica number idx=0. Then, processing similar to that in FIG. 16 is executed, assuming that the OSD of the server 200 in FIG. 16 is the primary OSD and the servers 200a and 200b in FIG. 16 are the secondary OSDs.

Note that, in step S82, two secondary OSDs are specified by inputting the replica numbers idx=1, 2 respectively as the arguments of the function choose_replica. Furthermore, in step S85, in the case where the primary OSD is present in the server 200, the response information of write completion is output to the workload execution unit 201 of the server 200. Thereby, the write complete is notified to the workload. Meanwhile, in the case where the primary OSD is present in a server other than the server 200, the response information of write completion is transferred to the arrangement calculation unit 231-1 of the server 200, and is output to the workload execution unit 201 of the server 200. Thereby, the write complete is notified to the workload.

In the above-described first modification, when an access to the object is requested from the workload, the magic pattern and the replica specification number i are embedded in the object name, so that the access request becomes able to be output to the OSD on the node to which the workload has been deployed. As a result, the possibility of improving the access speed for the object occurs, similarly to the second embodiment.

Furthermore, the first modification has the configuration of embedding the magic pattern and the replica specification number i in the object name and determining the presence or absence of the magic pattern by the parser 244. Thereby, control for limiting the output destination of the access request from the arrangement calculation unit 231-1 to its own node can be selectively applied. For example, whether to apply the above control can be determined according to processing performance needed for the workload.

<Second Modification>

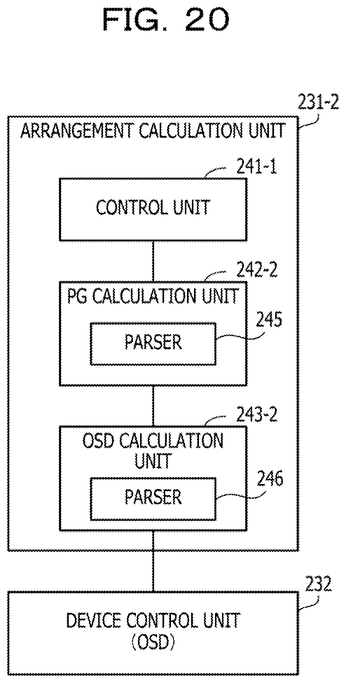

FIG. 20 is a diagram illustrating an internal configuration example of an arrangement calculation unit in a second modification. In the second modification the server 200 includes an arrangement calculation unit 231-2 illustrated in FIG. 20 instead of the arrangement calculation unit 231 illustrated in FIG. 6. Note that, in FIG. 20, components that execute the same processing as in FIG. 6 or 17 are illustrated with the same reference numerals. Furthermore, other servers have the same configuration as the server 200.

The arrangement calculation unit 231-2 includes the control unit 241-1, a PG calculation unit 242-2, and an OSD calculation unit 243-2 instead of the control unit 241, the PG calculation unit 242, and the OSD calculation unit 243 in FIG. 6.

The control unit 241-1 embeds a magic pattern and the replica specification number i in a specific field in the character string of the object name and outputting the character string when the replica specification number i is calculated, similarly to the control unit 241-1 in FIG. 17.

The PG calculation unit 242-2 is different from the PG calculation unit 242 in FIG. 6 in including a parser 245 therein. The parser 245 determines whether the magic pattern is present in the specific field of the object name when the control unit 241-1 outputs the object name together with the access request to the object of which the object name has been specified. In the case where the magic pattern is present, the parser 245 masks the fields of the magic pattern and the replica specification number i in the object name. In this case, the PG calculation unit 242-2 calculates the PG ID on the basis of the masked object name. The parser 245 outputs the calculated PG ID to the OSD calculation unit 243-2, and transfers the access request in which the object name before being masked is specified to the OSD calculation unit 243-2.

The OSD calculation unit 243-2 is different from the OSD calculation unit 243 in FIG. 6 in including a parser 246 therein. The parser 246 determines whether the magic pattern is present in the specific field of the object name output from the PG calculation unit 242-2. In the case where the magic pattern is present, the parser 246 extracts the replica specification number i from the object name. In this case, the OSD calculation unit 243-2 inputs the PG ID and the replica number idx=i as the arguments to the function choose_replica, and calculates the OSD ID. Furthermore, the parser 246 masks the fields of the magic pattern and the replica specification number i in the object name. The OSD calculation unit 243-2 transmits the access request in which the masked object name is specified to the OSD indicated by the calculated OSD ID.

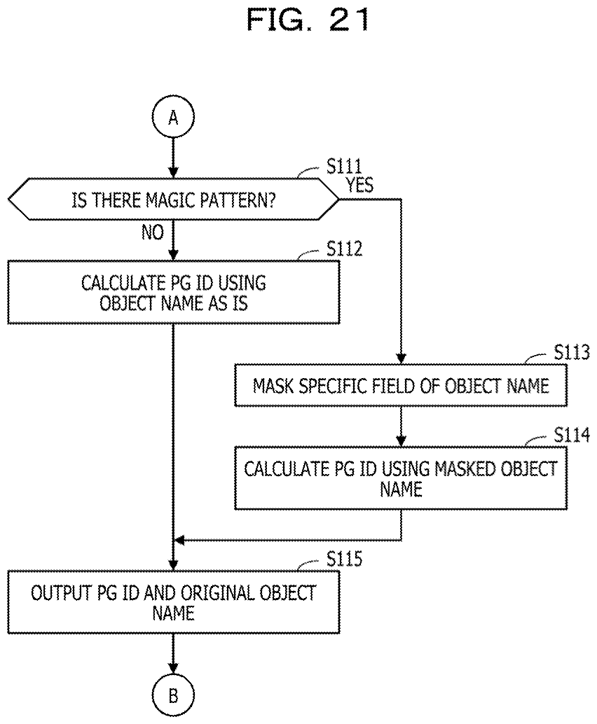

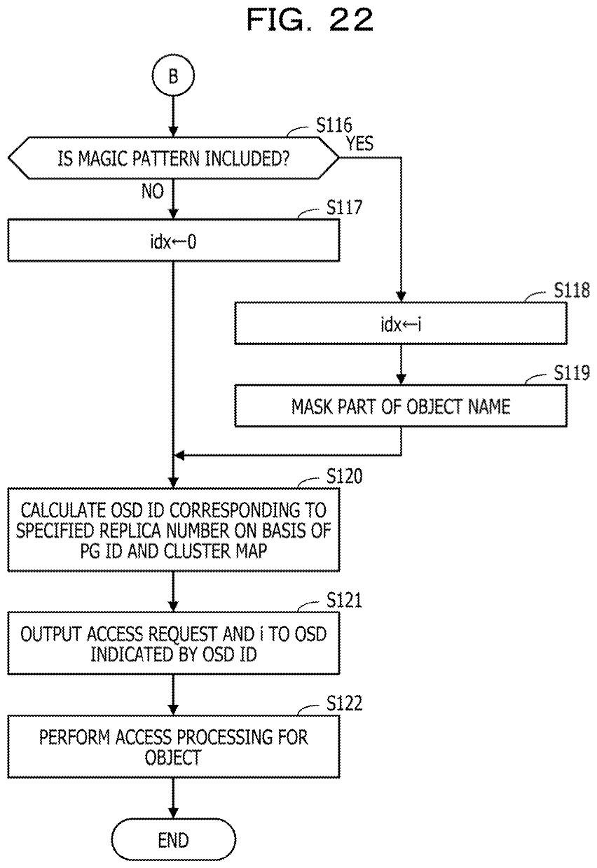

FIGS. 21 and 22 are examples of a flowchart illustrating a processing procedure of accessing an object in the second modification. As an example, it is assumed that the workload deployed to the server 200 is executed by the workload execution unit 201 in FIGS. 21 and 22, similarly to FIG. 15.

In the second modification, first, the processing illustrated in FIG. 18 is executed. Then, after the processing in step S94 or step S96 is executed, the processing in FIG. 21 is executed.

[step S111] The access request in which the object name is specified is input from the control unit 241-1 to the PG calculation unit 242-2. Then, the parser 245 of the PG calculation unit 242-2 analyzes the object name and determines whether there is the magic pattern in the specific field of the object name. The processing proceeds to step S113 in the case where there is the magic pattern, and the processing proceeds to step S112 in the case where there is no magic pattern.

[step S112] The PG calculation unit 242-2 calculates the PG ID on the basis of the object name. In this calculation, the original object name specified in the access request is used as it is.

[step S113] The parser 245 masks the field in which the magic pattern is described and the field in which the replica specification number i is described in the object name.

[step S114] The PG calculation unit 242-2 calculates the PG ID on the basis of the masked object name.

[step S115] The PG calculation unit 242-2 outputs the calculated PG ID to the OSD calculation unit 243-2, and transfers the input access request to the OSD calculation unit 243-2. At this time, the input original object name is transferred as it is regardless of whether the magic pattern and the replica specification number i are embedded in the object name.

[step S116] The parser 246 of the OSD calculation unit 243-2 analyzes the object name and determines whether there is the magic pattern in the specific field of the object name. The processing proceeds to step S118 in the case where there is the magic pattern, and the processing proceeds to step S117 in the case where there is no magic pattern.

[step S117] The parser 246 specifies the replica number idx=0 as the argument of the function choose_replica.

[step S118] The parser 246 extracts the replica specification number i from the object name and sets the replica number idx=i as the argument of the function choose_replica.

[step S119] The parser 246 masks the field in which the magic pattern is described and the field in which the replica specification number i is described in the object name.

[step S120] The OSD calculation unit 243-2 calculates the OSD ID of the OSD corresponding to the replica number idx specified in step S117 or S118 on the basis of the PG ID and the cluster map 222 from the PG calculation unit 242-2. That is, the OSD ID is calculated by inputting the replica number idx specified in step S117 or S118 as the argument of the function choose_replica.

[step S121] The OSD calculation unit 243-2 outputs the access request for the object to the OSD indicated by the calculated OSD ID. In the case where step S117 is executed, the object name input to the OSD calculation unit 243-2 is specified as it is in the access request. Meanwhile, in the case where step S119 is executed, the object name masked in step S119 (that is, the object name from which the magic pattern and the replica specification number i are deleted) is specified in the access request. Furthermore, in the latter case, the OSD calculation unit 243-2 outputs the replica specification number i together with the access request to the OSD.

Here, in the case where steps S118 and S119 are executed, the output destination of the access request is the OSD (device control unit 232) existing in its own node (that is, the server 200). Meanwhile, in the case where step S117 is executed, the output destination of the access request may be the OSD existing in its own node or may be the OSD existing in another node. In the latter case, the access request is transferred to another node (server) via the network 50.

[step S122] The access request is received by the OSD on the output destination, and the access processing by the OSD is executed. Note that, regarding the processing in the OSD, processing in which the wording in steps S98 and S99 is replaced with that in step S117, the wording in steps S100 and 101 is replaced with that in steps S118 and S119, and the wording in step S104 is replaced with that in step S121 in the description in step S105 in FIG. 19 is executed.

In the above-described second modification, when an access to the object is requested from the workload, the magic pattern and the replica specification number i are embedded in the object name, so that the access request becomes able to be output to the OSD on the node to which the workload has been deployed. As a result, the possibility of improving the access speed for the object occurs, similarly to the second embodiment and the first modification.

Furthermore, the second modification has the configuration of embedding the magic pattern and the replica specification number i in the object name and determining the presence or absence of the magic pattern by the parser 245 or 246. Thereby, control for limiting the output destination of the access request from the arrangement calculation unit 231-2 to its own node can be selectively applied. For example, whether to apply the above control can be determined according to processing performance needed for the workload.

Note that the processing functions of the devices described in each of the above embodiments (for example, the management device 1, the information processing devices 2a to 2d, the management server 100, and the servers 200, 200a, 200b, and the like) can be implemented by a computer. In that case, a program describing the processing content of the functions to be held by each device is provided, and the above processing functions are implemented on the computer by execution of the program on the computer. The program describing the processing content can be recorded on a computer-readable recording medium. The computer-readable recording medium includes a magnetic storage device, an optical disc, a magneto-optical recording medium, a semiconductor memory, or the like. The magnetic storage device includes a hard disk drive (HDD), a magnetic tape, or the like. The optical disc includes a Compact Disc (CD), a Digital Versatile Disc (DVD), a Blu-ray Disc (BD, registered trademark), or the like. The magneto-optical recording medium includes a Magneto-Optical (MO) disk or the like.

In a case where the program is to be distributed, for example, portable recording media such as DVDs and CDs, in which the program is recorded, are sold. Furthermore, it is possible to store the program in a storage device of a server computer and transfer the program from the server computer to another computer through a network.

The computer that executes the program stores, for example, the program recorded on the portable recording medium or the program transferred from the server computer in its own storage device. Then, the computer reads the program from the storage device of the computer and executes processing according to the program. Note that, the computer can also read the program directly from the portable recording medium and execute processing according to the program. Furthermore, the computer can also sequentially execute processing according to the received program each time when the program is transferred from the server computer connected via the network.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
a plurality of information processing devices; and
a management device, wherein
the management device selects a second device from among a plurality of first devices determined on a basis of identification information of an object from among the plurality of information processing devices, the plurality of first devices each storing the same object identified by the identification information, and arranges a task that uses the object in the second device, and
the second device generates specification information for specifying the second device from among the plurality of first devices on a basis of the identification information, and accesses the object stored in the second device on a basis of the specification information when accessing the object by execution of the task by the second device.

2. The information processing system according to claim 1, wherein
the specification information is generated on a basis of information indicating an order of the plurality of first devices, the information being determined on a basis of the identification information.

3. The information processing system according to claim 2, wherein
the processing of accessing the object includes an access destination determination process of determining the object stored in a first device of a predetermined number in the order of the plurality of first devices as an access destination on a basis of the identification information,
the specification information is information indicating what number's object in the order the object stored in the second device is, and
the access destination determination process is controlled to change the predetermined number to a number indicated by the specification information.

4. The information processing system according to claim 3, wherein
the second device further embeds the specification information and a predetermined pattern in a character string indicating the identification information when an access to the object is requested by execution of the task, and inputs the identification information to the access destination determination process, and
the access destination determination process
determines whether the predetermined pattern is present in the input identification information,
determines the access destination using the predetermined number as i in a case where the predetermined pattern is not present, and extracts the specification information from the identification information and masks areas of the specification information and the predetermined pattern in the character string of the identification information, and determines the access destination by using the masked identification information and changing the predetermined number to the number indicated by the extracted specification information in a case where the predetermined pattern is present.

5. The information processing system according to claim 3, wherein,
in a case where a write of the object is requested by execution of the task, the second device writes the object in a storage area included in the second device on a basis of a determination result of the access destination by the access destination determination process, then specifies another device other than the second device, of the plurality of first devices, from among the plurality of information processing devices, on a basis of the identification information and the specification information, and transfers the object to the specified other device and requests a write of the object.

6. The information processing system according to claim 1, wherein
the second device is selected on a basis of a resource usage status in each of the plurality of first devices.

7. An information processing device comprising:
a memory; and
a processor coupled to the memory and configured to:
receive a task using an object from a management device in response to the information processing device having been determined as an arrangement destination of the task by the management device, from among a plurality of first devices determined on a basis of identification information of the object from among a plurality of information processing devices including the information processing device, the plurality of first devices each storing the same object identified by the identification information;
generate specification information for specifying the information processing device from among the plurality of first devices on a basis of the identification information; and
access the object stored in the information processing device on a basis of the specification information when accessing the object by execution of the task by the information processing device.

8. The information processing device according to claim 7, wherein
the specification information is generated on a basis of information indicating an order of the plurality of first devices, the information being determined on a basis of the identification information.

9. The information processing device according to claim 8, wherein
the processing of accessing the object includes an access destination determination process of determining the object stored in a first device of a predetermined number in the order of the plurality of first devices as an access destination on a basis of the identification information,
the specification information is information indicating what numbers object in the order the object stored in the information processing device is, and
the access destination determination process is controlled to change the predetermined number to a number indicated by the specification information.

10. The information processing device according to claim 9, wherein
the processor further embeds the specification information and a predetermined pattern in a character string indicating the identification information when an access to the object is requested by execution of the task, and inputs the identification information to the access destination determination process, and
the access destination determination process
determines whether the predetermined pattern is present n the input identification information,
determines the access destination using the predetermined number as is in a case where the predetermined pattern is not present, and
extracts the specification information from the identification information and masks areas of the specification information and the predetermined pattern in the character string of the identification information, and determines the access destination by using the masked identification information and changing the predetermined number to the number indicated by the extracted specification information in a case where the predetermined pattern is present.

11. The information processing device according to claim 9, wherein,
in a case where a write of the object is requested by execution of the task, the processor writes the object in a storage area included in the information processing device on a basis of a determination result of the access destination by the access destination determination process, then specifies another device other than the information processing device, of the plurality of first devices, from among the plurality of information processing devices, on a basis of the identification information and the specification information, and transfers the object to the specified other device and requests a write of the object.

12. The information processing device according to claim 7, wherein
in the management device, the information processing device is selected on a basis of a resource usage status in each of the plurality of first devices.

1. 3. An access control method comprising:
by a computer,
receiving a task using an object from a management device in response to the computer having been determined as an arrangement destination of the task by the management device, from among a plurality of first devices determined on a basis of identification information of the object from among a plurality of computers including the computer, the plurality of first devices each storing the same object identified by the identification information;
generating specification information for specifying the computer from among the plurality of first devices on a basis of the identification information; and
accessing the object stored in the computer on a basis of the specification information when accessing the object by execution of the task by the computer.
